(19) United States
(12) Patent Application Publication
(10) Pub. No.: US 2013/0028729 A1
(43) Pub. Date: Jan. 31, 2013

(54) POWER GENERATION SYSTEMS AND METHODS

(71) Applicant: Jack A. JONES, LOS ANGELES, CA (US)

(72) Inventor: Jack A. JONES, LOS ANGELES, CA (US)

(21) Appl. No.: 13/560,436

(22) Filed: Jul. 27, 2012

Related U.S. Application Data
(60) Provisional application No. 61/512,848, filed on Jul. 28, 2011.

(51) Int. Cl. F03B 3/04

(52) U.S. Cl. 415/221

(57) ABSTRACT

A power generation system with a plurality of mechanical devices is described. Each mechanical device has energy-capturing blades and a hydraulic pump. A power generation arrangement remote of the mechanical devices is also disclosed. Each mechanical device can include a device output conduit configured to output a pressurized output flow and a device input conduit for receiving a low pressure flow. The power generation arrangement can comprise a plurality of hydraulic generators, such that each mechanical device can be connected to the plurality of hydraulic generators. A method for power generating is further disclosed, where a pressurized output flow can be delivered in parallel from the mechanical devices to the plurality of hydraulic generators. Some of the hydraulic generators can be switched off when the power transmitted from the blades is low.

### CROSS REFERENCE TO RELATED APPLICATIONS

The present application claims priority to U.S. provisional application 61/512,848 for “Pressure Modulation for Renewable Energy Systems” filed on Jul. 28, 2011, which is herein incorporated by reference in its entirety.

### STATEMENT OF GOVERNMENT GRANT

The invention described herein was made in the performance of work under a NASA contract, and is subject to the provisions of Public Law 96-517 (35 USC 202) in which the Contractor has elected to retain title.

### FIELD

The present disclosure relates to power generation systems and methods.

### BACKGROUND

Tidal energy and off-shore wind energy can be converted to electricity on-shore by conversion of such energies into high pressure hydraulic flows that are transmitted to shore by high pressure pipelines. The high pressure flows can then be converted to electricity by an on-shore generator plant.

### SUMMARY

According to a first aspect of the present disclosure, a power generation system is disclosed, the power generation system comprising a plurality of mechanical devices, each mechanical device comprising energy capturing blades and a pump, the blades being connected to the pump to power the pump, and a power generation arrangement remote of the mechanical device; wherein each mechanical device includes a device output conduit configured to output a pressurized output flow and a device input conduit adapted to receive a low pressure flow; the power generation arrangement comprises a plurality of hydraulic generators; and each mechanical device is connected to the plurality of hydraulic generators.

According to a second aspect of the present disclosure, a power generation system is disclosed, the power generation system comprising one or more mechanical devices, each mechanical device comprising energy capturing blades and a pump, the blades being connected to the pump by way of a rotational shaft in order to power the pump; and a power generation arrangement remote of the one or more mechanical devices; wherein the power generation arrangement includes a plurality of hydraulic generators; each of the hydraulic generators includes an input port and an output port; the mechanical device includes a device output conduit configured to output a pressurized output flow and a device input conduit adapted to receive low pressure flow; the device output conduit is connected to the input port through at least one main output conduit to deliver the pressurized output flow from the one or more mechanical devices to the hydraulic generators and the output port is connected to the device input conduit through at least one low pressure conduit to deliver the low pressure flow from the hydraulic generators to each mechanical device.

According to a third aspect of the disclosure, a power generation method is disclosed, the power generation method comprising providing one or more mechanical devices, each mechanical device comprising energy capturing blades and a pump; connecting the blades to the pump by way of a rotor to power the pump; providing a location for power generation, the location being remote of the one or more mechanical devices and including a plurality of hydraulic generators; associating a device output conduit to the one or more mechanical devices, the device output conduit being configured to output a pressurized output liquid flow, and associating a device input conduit to the one or more mechanical devices, the device input conduit being adapted to receive a low pressure flow; delivering the low pressure flow to the device input conduit of the one or more mechanical devices, transmitting a rotation speed from the blades to the pump to power the pump and to deliver the pressurized output liquid flow from the device output conduit of the one or more mechanical devices to the plurality of hydraulic generators through at least one main output conduit.

Further aspects of the disclosure are shown in the specification, drawings and claims of the present application.

### BRIEF DESCRIPTION OF THE DRAWINGS

FIG. 1 shows a schematic diagram of a power generation system according to an embodiment of the present disclosure.

FIG. 2 shows a schematic diagram of a power generation system according an embodiment of the present disclosure.

FIG. 3 shows a schematic diagram of a power generation system according a further embodiment of the present disclosure, where mechanical devices are located on one side of a pressurized conduit.

FIG. 4 shows a schematic diagram of a power generation system according a further embodiment of the present disclosure, where mechanical devices are located on different sides of a pressurized conduit.

FIG. 5 shows an efficiency curve for a blade-driven pump of a power generation system according to an embodiment of the present disclosure.

FIG. 6 shows efficiency curves for a hydraulic pump of a power generation system according to an embodiment of the present disclosure.

FIG. 7 shows a schematic diagram of a mechanical device according to a further embodiment of the present disclosure.

### DETAILED DESCRIPTION

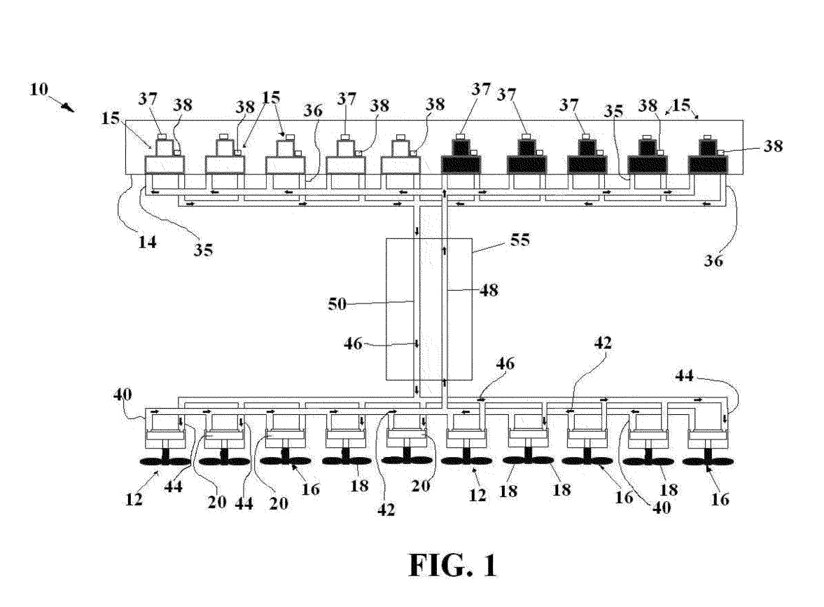

A power generation system (10) (110) according to some embodiments of the present disclosure is shown in FIGS. 1-4. Reference can also be made to references [1], [2], [3] and [4], incorporated herein by reference in their entirety. The power generation system includes a plurality of mechanical devices (12). In some embodiments of the present disclosure, the mechanical devices (12) can be configured to be located underwater, for example in a deep ocean current at a large distance from dry land. The depth of placement can be, for example, at least 30-60 m, thus allowing 10-40 m of navigable channel above the mechanical devices (12). In particular, the mechanical devices (12) can be configured to be activated by water current and to transmit hydraulic energy to a location (14) remote of the mechanical device (12) for power generation.

In other embodiments of the present disclosure, the mechanical devices (12) can be configured and located out of water, in order to be powered by wind. It follows that the power generation system (10, 110) of FIGS. 1-4 can transfer both offshore and onshore wind energy and tidal energy to the location (14). For the case of offshore wind, the location (14) can be located onshore, or on a platform offshore.

As shown in the FIGS. 1-4, each mechanical device (12) can be, in the case of underwater location, a submerged mechanical device and can comprise a blade-driven pump (16) including a plurality of energy capturing blades (18) and a pump (20). The blades (18) can be, for example, 18 m diameter tidal blades. Such blade-driven pump (16) can be capable of generating 1 MW in a tidal flow of 2.6 m/sec. In some embodiments of the present disclosure, the blades can rotate at 20 RPM (Revolutions Per Minute), for a maximum velocity wind of 12 m/sec (27 MPH). The pump (20) can be an off-the-shelf radial piston pump, having a typical efficiency of about 0.95. For example, the pump can be a Bosch-Rexroth/Hagglund radial piston pump (#MB2400-1950), having a maximum allowable speed of 24 RPM and maximum power output of about 1.41 MW. The blades (18) are connected to the pump (20) to power the pump, thus rotating the pump to produce a pressurized fluid flow. More in particular, in the example shown, water current can turn the blade-driven pump (16), which, in turn, can transmit rotation to the pump (20).

According to further aspects of the present disclosure, the pumps (20) can be variable displacement pumps or fixed displacement pumps, or any other type of pumps. The blades can be horizontal or vertical blades, such as but not limited to the three primary types of blades: VAWT Savonius, HAWT towered; and VAWT Darrieus.

According to some aspects of the present disclosure, the power generation system (10), (110) further includes a power generation arrangement (14) remote from the mechanical devices. The power generation arrangement (14) can be a hydroelectric power plant or a hydraulic power plant. More in particular, the arrangement (14) can include a plurality of hydraulic generators (15). Such generators can include a series of hydraulic generators which are connected in parallel to the above described mechanical devices (12). For example, in some embodiments, the hydraulic generators can include a series of off-the-shelf, high efficiency, axial piston hydraulic motors, which turn electric alternators or generators. It follows that according to some embodiments of the disclosure, the mechanical devices can be connected directly to a series of hydraulic generators which can be located in a common location (14). More in particular, the pumps (20) of the mechanical devices (20) can be directly connected in parallel to a series of hydraulic generators (15). According to some embodiments of the present disclosure, the hydraulic motors can include fixed displacement motors, variable displacement motors, and any other types of hydraulic motors.

In the embodiments shown in FIGS. 1-4, the mechanical device (12) can include a device output conduit (40) configured to output a pressurized output flow (42) from each pump (20) and a device input conduit (44) adapted to receive low pressure flow (46). Each of the hydraulic generators (15) can include an input port (35) and an output port (36). The device output conduits (40) can be connected in parallel to the input ports (35) of the hydraulic generators (15) through at least one main output conduit (48) to deliver the pressurized output flow (42) from the pump (20) to the hydraulic generators (15) of the arrangement (14). The device input conduits (44) can be connected in parallel to the output ports (36) of the hydraulic generators (15) through at least one low pressure conduit (50) to deliver the low pressure flow (46) from the arrangement (14) to the pump (20) of the mechanical device (12). It follows that the power generation system (10) (110) can comprise at least one common main output conduit (48) to deliver the pressurized output flow (42) from the plurality of mechanical devices (12) to the arrangement (14) and at least one common low pressure conduit (50) to deliver the low pressure flow (46) from the arrangement (14) to the plurality of mechanical devices (12). The device output conduit (40) of each mechanical device (12) can be in fluid communication with the input port (35) of each hydraulic generator (15) by way of the at least one main output conduit (48), while the device input conduit (44) of each mechanical device (12) can be in fluid communication with the output port (36) of each hydraulic generator by way of the at least one low pressure conduit (50). It can be noted that the number of main output conduits (48) and/or the number of low pressure conduits (50) can be larger than or equal to one. It can also be noted that, according to some embodiments of the present application, there can be a fluid cooling unit, schematically shown in FIG. 1 and indicated by reference number (55), in contact with the main output conduits (48) and/or the low pressure conduits (50). In particular, according to some embodiments, an oil cooler can be used to remove heat from main output conduits (48) and/or the low pressure conduits (50), especially for onshore wind, where there is no ocean to act as a cooler for energy inefficiencies that cause the oil to heat up.

According to several aspects of the present disclosure, the presence of a plurality of hydraulic generators (15) in a common location or common locations allows the power generations system to work according to a plurality of different operating modes. In particular, in a first operating mode, the pump (20) of each mechanical device (12) can be in fluid communication simultaneously and continuously with all the hydraulic generators (15) by way of the at least one main output conduit (48). In other words, all of the pumps can be always connected to the hydraulic generators (15) to power all of the hydraulic generators (15). Alternatively, according to different operating modes, the pump (20) of each mechanical device (12) can be in fluid communication with all the hydraulic generators (15), in a first operative condition, e.g. only during a first time period, and the pump (20) of each mechanical device (12) can be in fluid communication with a reduced number, or some, of the hydraulic generators (15), in a second operative condition, e.g. during a second time period. In other words, according to several aspects of the present disclosure, it is possible to change the number of the operative working hydraulic generators, such that a first number of the hydraulic generators (15) can receive the pressurized output flow (42) and, during a different time period, a second number of the hydraulic generators (15) can receive the pressurized output flow (42), wherein the first number differs from the second number. In particular, in the second operative condition, some hydraulic generators (15) are switched off, or are out of line, such that only some hydraulic generators (15) are in a working operative condition. These switched off hydraulic generators (15) are depicted in black in FIG. 1. According to some embodiments of the present application, the generators can include variable displacement hydraulic motors. Some of the hydraulic motors can be partially turned on. That is, if all the hydraulic motors were variable displacement motors, then it is possible to have, for example, 3 hydraulic motors turned on, another one partially open, and the rest closed (or turned off). It follows, that the displacement volume can change. In particular, it is possible to vary the displacement of one or more hydraulic motors to fine-tune the RPM of the motors. It follows that, according to some embodiments of the present disclosure, based on the presence of a plurality of hydraulic generators, it is possible to keep the generator RPM at a constant, or nearly constant RPM, so that the electricity generation efficiency remains optimal, and so that the voltage does not change much, if at all. One means of maintaining a nearly constant RPM can be to stop some of the hydraulic generators either by braking them (preferred) or closing a valve. Thus, fluid would stay in contact with the shutdown generators if they are in simply braked condition. Alternatively, it is possible to vary the displacement of one or more hydraulic motors to fine-tune the RPM.

According to several aspects of the present disclosure, the number of the switched-on hydraulic generators, or the variation of displacement of one or more hydraulic motors, can depend on the wind speed or the tidal energy, and therefore on the rotation speed of the blade-driven pump (16). The higher the rotation speed of the blades, the higher the number of switched-on hydraulic operators, or higher the displacement volume. For example, the first operative condition can correspond to a first rotation speed of the blade-driven pump (16) of the mechanical devices (12) and the second operative condition can correspond to a second rotation speed of the blade-driven pump (16) of the mechanical devices (12), wherein the first rotation speed is of different value with respect to the second rotation speed. In particular, according to several aspects of the present disclosure, some hydraulic generators can be in a switched-off condition, or operate under different conditions, such as for example by changing the total displacement of one or more hydraulic motors, on the basis of the rotation speed of the blade-driven pump (16). It follows that the efficiency of the entire power generation system (10, 110) can be controlled in relation to the mechanical energy of the blade-driven pump (16).

In some embodiments of the present disclosure, the power generation system (10, 110) can include one or more detection devices (37) configured to sense a rotation speed of one or more hydraulic generators (15) and one or more control devices (38) configured to control operation of the hydraulic generators (15) based on the rotation speed of the one or more hydraulic generators (15) In fact, it is desirable to maintain the RPM of the hydraulic generators at or near some fixed value so that the energy output efficiency is maximized and the generator RPM and voltage remain at or nearly constant.

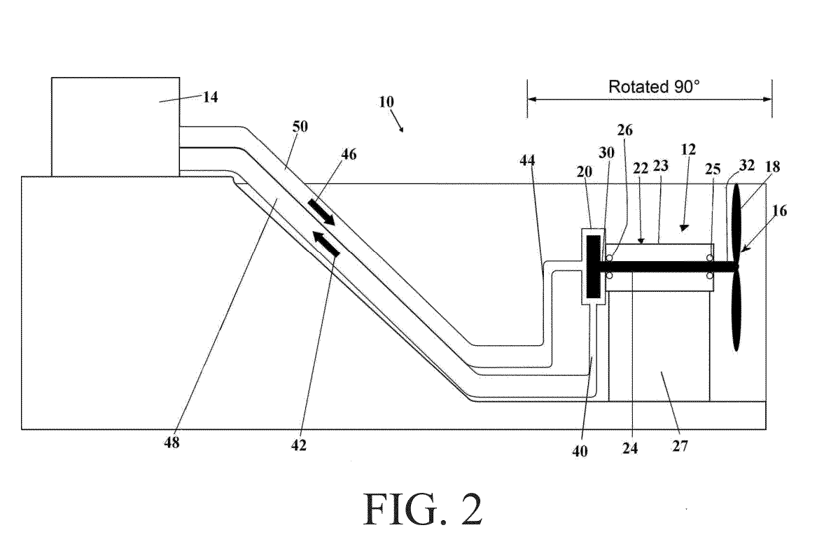

According to other aspects of the present disclosure, in the mechanical device (12), the blade-driven pump (16) can be directly connected to the pump (20) by way of a rotor (24). It follows that the mechanical device (12) can be devoid of any gearbox to increase rotational speed from the blades (18) to the pump (20). In fact, as shown in FIG. 2, in the mechanical device (12), the rotational shaft or rotor (24) can have a first rotor end (32) directly connected to the blades (18) and a second rotor end (30) directly connected to the pump (20). It follows that in the embodiment of FIGS. 1-4 mechanical gears can be eliminated so as to increase efficiency and to avoid the risk of failure of such mechanical gears. In particular, as shown in FIG. 2, the rotor (24) can be provided with seals and bearings schematically indicated by reference numbers (25), (26) to bear and seal the first rotor end (30) to the pump (20) and the second rotor end (32) to the blades (18).

It follows that, according to several embodiments of the present disclosure, a rotation speed of the blades (18) can be equal, or substantially equal, to a rotation speed of the pump (20). The rotational speed to rotate the pump (20) cannot therefore increase between the blades (18) and the pump (20). Therefore, when the blade-driven pump (16) is powered by flowing or undulating water or other flow currents, the blades (18) rotates with a rotational speed which is able to directly activate the pump (20).

It follows that the RPM of the pump is approximately proportional to a tidal flow velocity or wind velocity. For example, by using the blades (18) described in the previous paragraphs at a tidal flow of 2.6 msec, RPM is approximately 12 RPM. Such RPM and torque can match very well with the Hagglunds #MB2400 radial piston pump. Such pump does not require gear reduction, thus avoiding a major energy loss and maintenance problem. The MB2400 has, as previously anticipated, a maximum allowable speed of 24 RPM and maximum power output of about 1.41 MW. Table 1 reported here below shows Hydraulic Pressure-Modulated Operating Parameter. From this table, it is confirmed that RPM of the pump varies approximately proportionately with the tidal flow velocity. It is further noted that the power removed from the tidal flow is proportional to the cube of the flow velocity. Since the hydraulic power is proportional to the RPM times the pressure drop for a fixed displacement pump, the pressure drop can be varied accordingly to transmit the correct amount of hydraulic energy to the generator.

| | | | | | Difference |
|---|---|---|---|---|---|
| Tide | | | Pressure of the low | Pressure of the | between high |
| Velocity | Power (MW) of | RPM of | pressure conduit | main out put | and low pressure |
| (m/sec) | the pump | the pump | (bar) | conduit (bar) | (bar) |
| 1.5 | 0.19 | 6.9 | 10 | 93.7 | 83.7 |
| 2.0 | 0.46 | 9.2 | 10 | 162.0 | 152.0 |
| 2.6 | 1.00 | 12.0 | 10 | 263.9 | 253.9 |
| 3.0 | 1.54 | 13.8 | 10 | 350.0 | 340.0 |

As also shown in FIGS. 1-4, the mechanical device (12) can include a mantel-shaped housing (22). The mantel-shaped housing (22) can be a tubular case. In particular, the mantel-shaped housing (22) can include a jacket (23) to house the rotor (24) and at least partially the pump (20). The mantel-shaped housing (22) can be a stationary housing which is located in a submerged location. For example, in FIG. 2, the mantel-shaped housing (22) is located on a support base (27), or anchor, such as a gravity base, which is made, for example, of concrete. The pump (20) can be supported in the mantel-shaped housing (22) by way of supporting bars, radially located between a pump housing and the jacket (23).

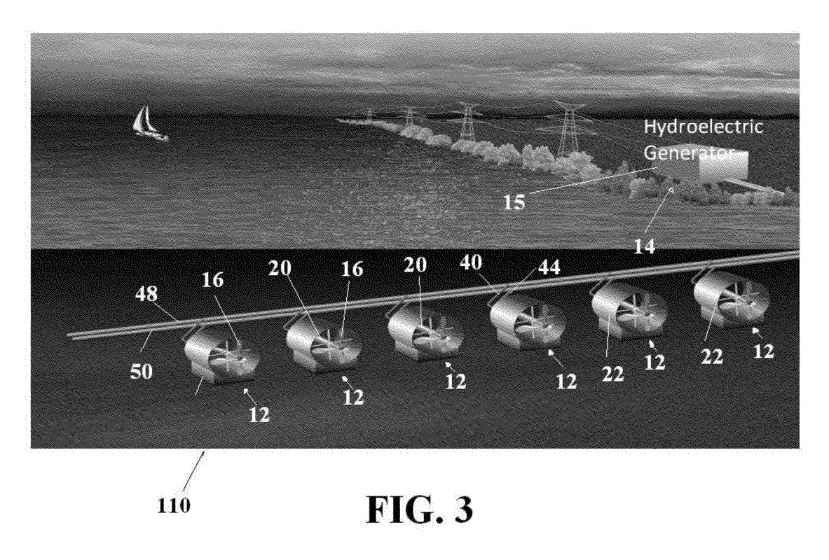

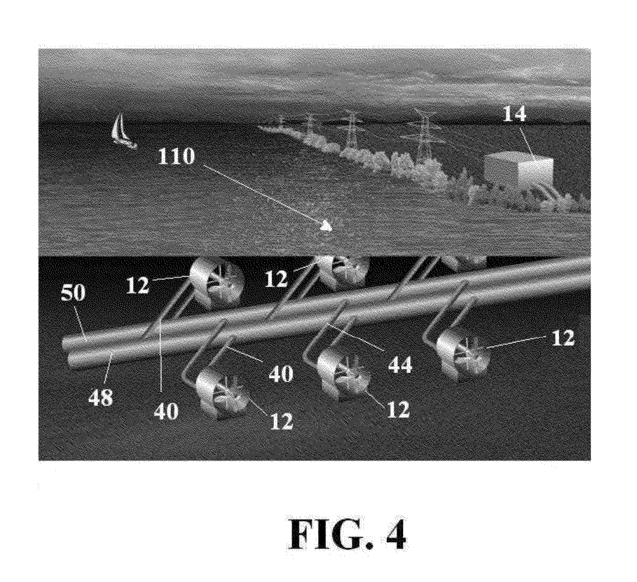

According to further embodiments of the present disclosure, further examples of power generation systems (110) are shown is FIGS. 3 and 4. The power generation systems of FIGS. 3 and 4 can include all of the features of the power generation system of FIG. 1, and all of the features and components disclosed in the previous paragraphs. The power generation system of FIG. 3 differs from the power generation system of FIG. 4 for the location of the mechanical devices (12). In the power generation system of FIG. 3, the mechanical devices (12) are all located on one side of the main pressurized conduit (48) and the low pressure conduit (50). In the power generation system (110) of FIG. 4, the mechanical devices (12) are distributed on both sides of the main pressurized conduit (48) and the low pressure conduit (50).

According to further aspects of the present disclosure, the power generation system (10, 110) can operate in a closed cycle mode. Schematics of how the system of the present disclosure can operate in the closed cycle mode are shown in FIGS. 1-4. In the closed cycle design, a liquid, such as for example non-toxic, environmentally friendly, biodegradable polyethylene glycol, is pressurized in device output conduits (40) by the pump (20). According to further embodiments, the liquid can be fresh water, salt water, oil, water solutions etc. The pressurized flow is sent though the main conduit (48) to the arrangement (14) where power is generated in a conventional hydroelectric plant or a hydraulic generator plant. Arrows coming out of the mechanical devices (12) along device output conduits (42) represent high pressure liquid (3000 psi or 207 bar) sent to the plant through the main conduit (48). After power generation, high pressure liquid becomes low pressure liquid (150 psi or 10.3 bar). The low pressure liquid is then returned to the mechanical devices (12) and is cyclically pressurized by the pump (20). Arrows going into mechanical devices (12) represent the low pressure liquid. This type of closed cycle design not only can eliminate all troublesome gears, it also allows many ground-based generators to be in a common location. The main output conduit (48) shown in FIGS. 1-4 can be a steel-reinforced concrete or a stainless steel pipe, 500 m long and have a diameter of about 0.25 m or more (for example 0.35 m). The low pressure input conduit (50) shown in FIGS. 1-4 can be a reinforced fiberglass pipe, 500 m long and have a diameter of about 0.25 m or more (e.g. 0.40 m). The high pressure device output conduit (40) and the device input conduit (44) can be flexible in order to allow for pump motion relative to the main conduits, thus allowing for sway of the submerged pumps with waves and currents. In the embodiment of FIGS. 3 and 4, the returning low pressure flow is separated and delivered to each device input conduit (44) to allow each individual flow to return to a single mechanical device (12). According to further alternative embodiments of the present disclosure, the power generation system (10, 110) can operate in an open cycle mode. The open cycle design differs from the closed cycle design in that liquid is not returned to the mechanical devices (12) and low pressure flow can include fresh liquid.

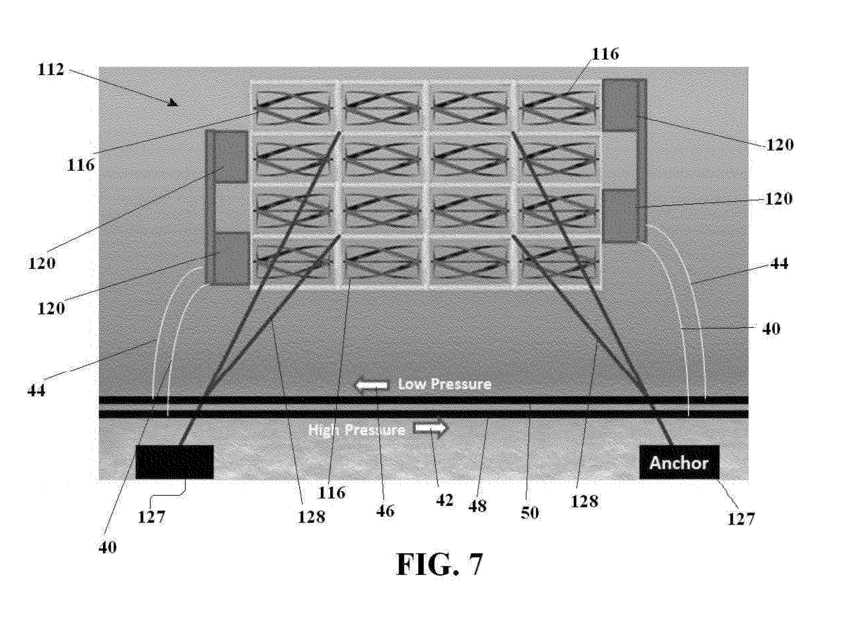

According to further embodiments of the present disclosure, the blades (18) shown in FIGS. 1-4 can be replaced by cross-flow blades (116) as that shown in FIG. 7. In FIG. 7, the remaining parts or components of the power generation system can be the same of those disclosed in the previous paragraphs. The cross-flow blades (116) can be, for example, those produced by Ocean Renewable Power Company (ORPC). These units can be stacked vertically and horizontally into much larger mechanical devices (112), which are fixed on the ground anchor (127) by means of tie members (128). A 4×4 unit mechanical device (112) can produce about 763 kW in a 2.6 m/sec tidal flow. The cross-flow blades (116) of FIG. 7 rotates in one direction only, regardless of current flow direction and can be used in combination with a generator not requiring a gearbox. The mechanical device (112) can include four submerged pumps (120), similar to those mentioned above in relation to the embodiments shown in FIGS. 1-4. In particular, the pumps (120) can be Hagglund CM 280 pumps. More in particular, each mechanical device (112) can include a matrix of 4×4 units, wherein each group of four cross-flow blades (116) can be connected to a corresponding pump (120). For example, in some embodiments of the present application, a power generation system can include six mechanical devices (112) of 4×4 units, one of which is shown in FIG. 7, to produce a total of 4 MW peak power. In these embodiments, the main out conduit (48) can be made of stainless steel and have an average 20 cm ID (internal diameter). The low pressure conduit (50) can be made of reinforced fiberglass and have average 25 cm ID, to give again a total system pressure drop loss of 5%. The fluid can be non-toxic, environmentally friendly, biodegradable polyethylene glycol and the amount of this fluid can be 10,000 gallons. It can be noted that, since polyethylene glycol is fully miscible with water, if the entire quantity of glycol would leak in a single tidal flow, total mixed content of glycol with seawater would be about 30 parts per billion, assuming complete mixing for application in Maine's Western Passage.

A method for operating the power generation system (10, 110) and to generate power is disclosed in the following paragraphs. In particular, in operation, the pump (20, 120) of each mechanical device (12, 112) can be powered by mechanical energy of the blades (18), or the cross-flow blades (116), to deliver the pressurized output flow (42) in the device output conduit (40). The pressurized output flow (42) can be then delivered into the main output conduit (48). The liquid can then be delivered, as a return flow, to the mechanical device (12, 112). Therefore, based on several aspects of the present disclosure, the power generation system (10, 110) can utilize a series of off-the-shelf radial piston pumps (20), which can send a bio-friendly fluid directly and in parallel to a series of off-the-shelf, high efficiency, axial piston hydraulic generators.

According to some aspects of the present disclosure, as the wind speed, or water current speed, decreases, the pressure drop decreases, and the generator performance can be maintained at an optimum RPM by shutting off some of the hydraulic generators (15), or by varying the displacement of one or more hydraulic motors. In fact, as the wind or the water current decreases, various hydraulic generators can be shut down, or the displacement of one or more hydraulic motors can be varied, to produce a nearly constant high RPM. Also, if there is a failure of one or more generators, they can easily be taken off-line (FIG. 1).

A performance of a power generation system (10, 110) according to several embodiments of the present disclosure is disclosed, for exemplary purposes, in the following paragraphs. For onshore and offshore wind, fifteen mechanical devices have been sized, although much larger power systems can be scaled up. In particular, fifteen mechanical devices including 1.0-MW, 60-m diameter blades can be selected, wherein each blade-driven pump (16) can rotate at 20 RPM, for a maximum velocity wind of 12 msec (27 MPH). Each blade-driven pump (16) can be connected to a Bosch-Rexroth/Hagglund radial piston pump (#MB2400-1950). For this particular example, a series of hydraulic generators (15) can be located 500 meters away from the wind pump units, or pumps (20, 120). An average ID of the high-pressure (3000 psi or 207 bar) stainless steel pipe, or main output conduit (48), can be 35 cm and an average ID of the low-pressure (150 psi or 10.3 bar) RFP pipe, or low pressure conduit (50), can be 40 cm. Total pressure drop can be 5% of the entire flow for the 500-m×2 roundtrip length (along the main output conduit (48) and the low pressure conduit (50)). Distances longer than 500 meters can require larger diameters in order to maintain the same 5% total pressure drop loss. All equipments can be commercial-off-the-shelf (COTS) components. By way of example, the total efficiency of the power generation system can be as follows for full rated flow velocity:

$$\begin{matrix}Total Efficiency = Pump Effic * Pressure Effic * \\ Hydraulic Motor Effic * Generator Effic \\ = about 0.95 * 0.95 * 0.95 * 0.95 \\ = about 0.814\end{matrix}$$

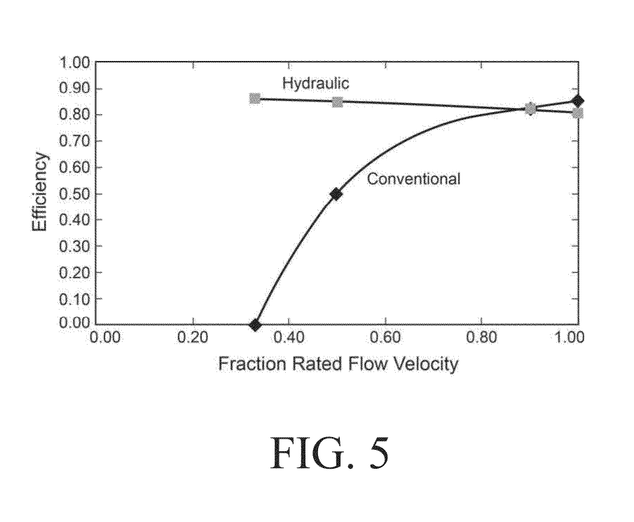

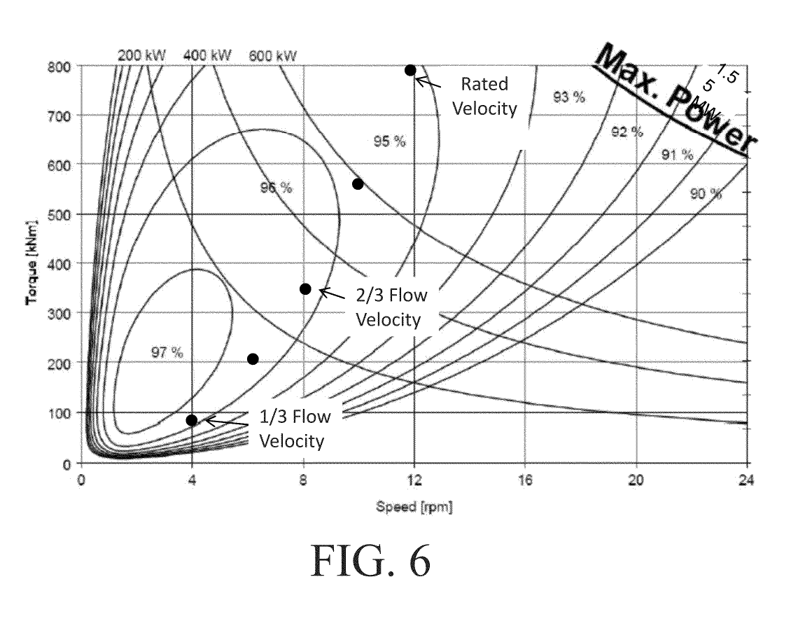

As shown in FIG. 6, it appears that at ⅓ of the full rated flow speed, the hydraulic pump efficiency can increase to about 0.963 and the pressure drop efficiency can increase to at least 0.99. The hydraulic motor and generator efficiency both can stay at 0.95 by means of shutting off generators. Thus, total efficiency can increase to about 0.860 (FIG. 5). It is further remarked that the efficiency curves of the MB2400-1950 for wind turbines can be shifted for the somewhat higher RPMs and lower torques corresponding to wind turbines. The resulting total efficiency numbers for both hydraulic wind and tidal energy systems can be thus very similar and are shown, for example purposes, in FIG. 5. It appears that the power generation system according to several embodiments of the present disclosure can provide a large improvement over other wind turbine systems, which suffer significantly lower efficiency at low wind speeds. In fact, conventional wind turbine combined gear/electronic efficiencies, as those disclosed in reference [2], excluding power conditioning, vary from about 0.87 (full rated wind velocity), to about 0.5 at half rated velocity, and to zero (⅓ rated velocity). The general shape of the “Hydraulic” curve in FIG. 5 has, in fact, been proven in an ongoing Hydraulic Tidal Energy Task (see reference [3]).

A possible number of switched-on hydraulic generators in relation to the tide velocity is shown, for example in Table 2, reported here below.

TABLE 2

| | | Flow | |
|---|---|---|---|
| Tide Velocity | Power | Rate (% | Number of |
| (m/sec) | (MW) | Max) | Generators |
| 1.5 | 0.19 | 0.5 | 5 |
| 2.0 | 0.46 | 0.67 | 7 |
| 2.6 | 1.00 | 0.87 | 9 |
| 3.0 | 1.54 | 1.0 | 10 |

It can be noted that various other means of controlling the output voltage and/or system efficiency can be related to sensing wind speed, sensing blade rotation speed, sensing pressure in an accumulator, changing blade angle adjustment, and so forth.

The examples set forth above are provided to give those of ordinary skill in the art a complete disclosure and description of how to make and use the embodiments of the disclosure, and are not intended to limit the scope of what the inventors regard as their disclosure. Modifications of the above-described modes for carrying out the disclosure, including pressure control devices, accumulators, and so forth, may be used by persons of skill in the art, and are intended to be within the scope of the following claims. All patents and publications mentioned in the specification may be indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

A number of embodiments of the disclosure have been described. Nevertheless, it will be understood that various modifications may be made without departing from the spirit and scope of the present disclosure. Accordingly, other embodiments are within the scope of the following claims.

### LIST OF REFERENCES

[1] JPL/Caltech Hydraulic Tidal and Wind Power Patent Input, Jack A. Jones, Jun. 27, 2012
[2] Renewable Energy World Conference, Long Beach, Calif., February, 2012; On-Shore Central Hydraulic Power Generation for Wind and Tidal Energy
[3] Sunlight Photonics, Inc., DE-EE0003636, “Tidal Energy System for On-shore Power Generation,” Marine and Hydrokinetic Technology Readiness Initiative, 2012
[4] Poster of Hydraulic Energy Transfer at 5th Annual Global Marine Renewable Energy Conference, Apr. 24-26, 2012

1. A power generation system comprising:
a plurality of mechanical devices, each mechanical device comprising energy capturing blades and a pump, the blades being connected to the pump to power the pump, and
a power generation arrangement remote of the mechanical device;
wherein:
each mechanical device includes a device output conduit configured to output a pressurized output flow and a device input conduit adapted to receive a low pressure flow;
the power generation arrangement comprises a plurality of hydraulic generators;
and
each mechanical device is connected to the plurality of hydraulic generators.

2. The power generation system of claim 1, wherein the mechanical devices are connected in parallel to the plurality of hydraulic generators.

3. The power generation system of claim 1, further comprising at least one main output conduit to deliver the pressurized output flow from the plurality of mechanical devices to the plurality of hydraulic generators and at least one low pressure conduit to deliver the low pressure flow from the power generation arrangement to the plurality of mechanical devices.

4. The power generation system of claim 3, wherein the device output conduit of each mechanical device is in fluid communication directly with the hydraulic generators by way of the at least one main output conduit and the device input conduit of each mechanical device is in fluid communication directly with the hydraulic generators by way of the at least one low pressure conduit.

5. The power generation system of claim 3, wherein each mechanical device is in fluid communication with all the hydraulic generators by way of the at least one main output conduit and the at least one low pressure conduit.

6. The power generation system of claim 1, wherein, in a first operative condition, the mechanical devices are in fluid communication with all the hydraulic generators and, in a second condition, the mechanical devices are in fluid communication with a reduced number, or some, of the hydraulic generators.

7. The power generation system of claim 1, wherein the hydraulic generators include hydraulic motors and, in a first operative time period, a number of the hydraulic generators are configured to displace a first displacement volume of fluid and, in a second operative time period, a number of the hydraulic generators are configured to displace a second displacement volume of fluid, wherein the first volume differs from the second volume.

8. The power generation system of claim 1, further comprising
one or more detection devices configured to sense a rotation speed of one or more hydraulic generators of the mechanical devices and
one or more control devices configured to control operation of the hydraulic generators based on the rotation speed of the one or more hydraulic generators.

9. The power generation system of claim 1, further comprising
one or more control devices configured to change the displacement and/or switch off/on operation of the hydraulic generators based on the rotation speed of the one or more generators.

10. The power generation system of claim 1, wherein in each mechanical device set of blades are directly connected to the pump by way of a rotor.

11. The power generation system of claim 1, wherein each mechanical device is devoid of any gearbox to increase rotational speed from the blades to the pump.

12. The power generation system of claim 1, wherein the pump is a off-the-shelf radial piston pump, a fixed displacement pump, a variable displacement pump, or any type of pump.

13. The power generation system of claim 1, wherein the hydraulic generators are off-the-shelf axial piston hydraulic generators, fixed displacement hydraulic generators, variable displacement hydraulic generators, or any type of hydraulic generator.

14. The power generation system of claim 1, wherein the blades are adapted to be powered by flowing or undulating water or by wind, the blades being able to activate the pump.

15. The power generation system of claim 1, wherein the power generation arrangement is a common location of the hydraulic generators.

16. A power generation system comprising:
one or more mechanical devices, each mechanical device comprising energy capturing blades and a pump, the blades being connected to the pump by way of a rotational shaft in order to power the pump; and
a power generation arrangement remote of the one or more mechanical devices;
wherein:
the power generation arrangement includes a plurality of hydraulic generators;
each of the hydraulic generators includes an input port and an output port;
the mechanical device includes a device output conduit configured to output a pressurized output flow and a device input conduit adapted to receive low pressure flow;
the device output conduit is connected to the input port through at least one main output conduit to deliver the pressurized output flow from the one or more mechanical devices to the hydraulic generators and
the output port is connected to the device input conduit through at least one low pressure conduit to deliver the low pressure flow from the hydraulic generators to each mechanical device.

17. The power generation system of claim 16, wherein, in a first operative time period, a first number of the hydraulic generators are in a switched on or partially switched on condition to receive the pressurized output flow and, in a second operative time period, a second number of the hydraulic generators are in a switched on or partially switched on condition to receive the pressurized output flow, wherein the first number differs from the second number.

18. The power generation system of claim 17, wherein the first operative time period is related to a first rotation speed of the blades and the second operative time period is related to a second rotation speed of the blades of the one or more mechanical devices, the first rotation speed being of different value with respect to the second rotation speed.

19. The power generation system of claim 16, wherein, in a first operative time period, a first number of the hydraulic generators are in a switched on condition to displace a first volume of fluid and, in a second operative time period, a second number of the hydraulic generators are in a switched on condition to displace a second volume of fluid, wherein the first volume differs from the second volume.

20. A power generation method, comprising:
providing one or more mechanical devices, each mechanical device comprising energy capturing blades and a pump;
connecting the blades to the pump to power the pump;
providing a location for power generation, the location being remote of the one or more mechanical devices and including a plurality of hydraulic generators;
associating a device output conduit to the one or more mechanical devices, the device output conduit being configured to output a pressurized output liquid flow, and associating a device input conduit to the one or more mechanical devices, the device input conduit being adapted to receive a low pressure flow;
delivering the low pressure flow to the device input conduit of the one or more mechanical devices,
transmitting a rotation speed from the blades to the pump to power the pump and to deliver the pressurized output liquid flow from the device output conduit of the one or more mechanical devices to the plurality of hydraulic generators through at least one main output conduit.

21. The power generation method of claim 20, further comprising:
monitoring a rotation speed of one or more of the hydraulic generators and
switching off, or changing a displacement volume of, one or more of the hydraulic generators based on the monitored rotation speed.

22. The power generation method of claim 21, wherein, when one or more of the hydraulic generators are switched off, a remaining number of the hydraulic generators are in a switched-on condition, and wherein the device output conduits of the mechanical devices deliver the pressurized flow to the remaining number of the hydraulic generators.

23. The power generation method of claim 20, wherein the one or more mechanical devices deliver the pressurized output liquid flow in parallel to the plurality of hydraulic generators.

24. The power generation method of claim 20, wherein in order to maintain RPM of the hydraulic generators nearly constant, some of the hydraulic generators are stopped, or displacement of some displacement motors of the hydraulic generators is controlled to fine tune the RPM.

25. The power generation method of claim 20, wherein the low pressure flow is delivered from the plurality of hydraulic generators to the device input conduit of the one or more mechanical devices, thus determining a returning low pressure flow from the plurality of hydraulic generators to the one or more mechanical devices.
